(19) United States
(12) Patent Application Publication
(10) Pub. No.: US 2026/0343145 A1
(43) Pub. Date: Oct. 29, 2026

(54) PRE-CONFIGURING OF AUDIO PROCESSING USING SUPPLEMENTAL TRANSDUCERS

(71) Applicant: Shure Acquisition Holdings, Inc., Niles, IL (US)

(72) Inventor: William Wallace Taylor, III, Gurnee, IL (US)

(73) Assignee: Shure Acquisition Holdings, Inc., Niles, IL (US)

(21) Appl. No.: 19/188,219

(22) Filed: Apr. 24, 2025

(51) Int. Cl. H04R 3/02; G01H 17/00; H04R 1/08

(52) U.S. Cl. CPC H04R 3/02; G01H 17/00; H04R 1/086; H04R 2430/01

(57) ABSTRACT

A microphone assembly and accompanying audio system are described, with the microphone assembly implementing multiple transducers that may independently generate their respective transducer signals in a temporally-offset manner. An audio pipeline may receive the transducer signals and use the initially-received transducer signal to pre-configure an audio processing configuration for subsequent audio processing of the other transducer signal once it is received. Such audio processing pre-configurations may include adjusting an audio gain, analog and/or digital filter configurations, adjusting various parameters of executed DSP algorithms for pop detection, to enable voice changing models, to perform voice isolation, pitch correction, clipping prevention, etc.

### FIELD

Aspects described herein generally relate to audio processing using supplemental transducers and, more particularly, to microphone assemblies that implement supplemental transducers to provide a secondary transducer signal prior to a primary transducer signal, which enables a pre-configuration of audio processing for the primary transducer signal.

### BACKGROUND

Microphone assemblies often implement transducers, such as audio transducers (e.g. microphones) to convert sound to audio signals, which may comprise electrical signals that are provided to an accompanying speaker to produce sound. The audio signals provided in this manner may be subjected to audio processing to generate output audio signals that are then transmitted to an appropriate speaker and/or other various components of a sound distribution system. This audio processing may be performed, at least in part, via an audio pipeline, which functions to condition the audio signals to generate corresponding output audio signals that are used to produce an accompanying sound. As part of this process, the audio pipeline may perform various operations in the analog and/or digital domain to ensure the output audio signal is of a desirable quality.

For instance, an audio pipeline may include analog and/or digital filters and/or digital signal processors (DSPs), which may execute DSP algorithms on audio samples corresponding to a received transducer signal, perform various DSP operations, filtering, amplification, to utilize audio compression, encoding, decoding, etc. Thus, the audio processing may be applied to the received audio signal to provide an output audio signal. However, although the audio processing may increase the quality of the accompanying sound, such audio processing operations utilize processing resources and introduce latency, thereby reducing performance. Additionally, the complexity and latency introduced by DSP algorithms in particular limits their implementation for real-time audio applications. This is because significant time is required to respond to output audio signal feedback and adjust the DSP algorithm operations or other parameters of the audio pipeline configuration for processing of subsequent audio samples. This leads to undesirable performance issues, which may manifest as audio artifacts such as pops, clipping, etc., which may persist until remedied via further time-consuming DSP operations. Thus, the current solutions for microphone assembly design and audio processing of signals received via such microphone assemblies have thus far been inadequate.

### SUMMARY

The following presents a simplified summary of the disclosure to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description that follows.

Again, conventional microphone assemblies and their accompanying audio systems have various drawbacks. For instance, for many conventional microphone assemblies, a single audio transducer is implemented, such as a microphone, which provides a single audio signal that is subjected to audio processing. By using only a single audio transducer, conventional audio processing techniques are limited to processing a single audio data stream that is associated with a single transducer source. As a result, the audio processing needs to continuously adapt to any changes in the audio signal to ensure quality sound is delivered, which typically requires an audio feedback system that requires time to provide such adjustments, as noted above.

The embodiments described herein address these issues and improve upon the performance of audio systems via the use of a microphone assembly that may implement a primary transducer used to provide audio signals that are subjected to audio processing, as well as one or more secondary transducers. These primary and secondary transducers may be spatially offset from one another or otherwise be configured to generate respective transducer signals that are received via a corresponding audio pipeline at different times with respect to one another. These secondary transducers may be referred to herein as supplemental or ancillary transducers, and may also comprise audio transducers. Alternatively, the supplemental transducers may be a different transducer type as the primary transducer, such as a vibration transducer, which may comprise for example an accelerometer, a gyroscope, an inertial monitoring unit (IMU), etc., as further discussed herein.

Regardless of the transducer types that are implemented or how the primary and secondary transducers are disposed relative to one another within the microphone assembly, the transducers may independently generate their respective transducer signals in a temporally-offset manner. As a result, the audio pipeline used for audio processing may also receive the transducer signals in a temporally-offset manner. In other words, the audio pipeline may receive a transducer signal from the secondary transducer (referred to herein as a secondary, supplemental, or ancillary transducer signal) prior to the receiving a transducer signal from the primary transducer (referred to herein as a primary transducer signal).

As a result, the secondary transducer signal may function as an information “probe,” which allows the audio pipeline to receive an initial sampling of audio and/or environmental information prior to receiving the primary transducer signal. In this way, the audio pipeline may use information gathered from processing the secondary transducer signal to pre-configure the audio processing used for the primary transducer signal once the primary transducer signal is received. Such pre-configurations may include setting and/or adjusting an amplifier gain, setting and/or adjusting an automatic gain control (AGC) parameters, setting and/or adjusting analog and/or digital filter configurations, setting and/or adjusting various parameters of executed DSP algorithms for pop detection, to enable voice changing models, real time pitch correction, to perform voice isolation, etc.

As described in more detail herein, this application sets forth methods, apparatuses, and systems for improving the audio processing of audio signals to reduce latency and improve audio performance.

An example microphone assembly may comprise a first transducer configured to generate a first transducer signal; and a second transducer spatially offset from the first transducer and configured to generate a second transducer signal before the first transducer generates the first transducer signal, wherein the first transducer signal and the second transducer signal are received by an audio pipeline independently of one another, and wherein the second transducer signal is received by the audio pipeline prior to the first transducer signal, which facilitates the audio pipeline pre-configuring audio processing to be performed on the first transducer signal in accordance with one or more parameters to output an audio signal.

An example audio system may comprise a microphone assembly comprising a first transducer and a second transducer spatially offset from one another; and an audio pipeline configured to: receive a second transducer signal generated via the second transducer independently of and prior to receiving a first transducer signal generated via the first transducer; and pre-configure, based upon an analysis of the second transducer signal, audio processing to be performed on the first transducer signal in accordance with one or more parameters to output an audio signal.

An example method may comprise receiving a first transducer signal generated via a first transducer of a microphone assembly; receiving a second transducer signal generated via a second transducer of the microphone assembly, wherein the second transducer signal is received independently of and prior to receiving the first transducer signal; pre-configuring, based upon an analysis of the first transducer signal, audio processing to be performed on the first transducer signal in accordance with one or more parameters; and outputting an audio signal by performing the audio processing on the first transducer signal.

It is noted that although the embodiments may be described herein in terms of a microphone assembly and audio system, this is by way of example and not limitation. These as well as other novel advantages, details, examples, features and objects of the present disclosure will be apparent to those skilled in the art from following the detailed description, the attached claims and accompanying drawings, listed herein, which are useful in explaining the concepts discussed herein.

### BRIEF DESCRIPTION OF THE DRAWINGS

Some features are shown by way of example, and not by limitation, in the accompanying drawings. In the drawings, like numerals reference similar elements.

FIG. 1 illustrates a block diagram of an example audio system that may be used to implement one or more illustrative aspects described herein.

FIG. 2A illustrates a block diagram of a first example microphone assembly that may be used to implement one or more illustrative aspects described herein.

FIG. 2B illustrates a block diagram of a second example microphone assembly that may be used to implement one or more illustrative aspects described herein.

FIG. 3 is a block diagram showing example details of the various components that may be part of an audio system in accordance with one or more illustrative aspects described herein.

FIG. 4 illustrates an example flow chart of a process that may be performed in accordance with one or more illustrative aspects described herein.

### DETAILED DESCRIPTION

In the following description of the various examples, reference is made to the accompanying drawings, which form a part hereof, and in which is shown by way of illustration various examples in which aspects may be practiced. References to “embodiment,” “example,” “aspect,” and the like indicate that the embodiment(s) or example(s) of the disclosure so described may include particular features, structures, or characteristics, but not every embodiment or example necessarily includes the particular features, structures, or characteristics. Further, it is contemplated that certain embodiments or examples may have some, all, or none of the features described for other examples. And it is to be understood that other embodiments and examples may be utilized and structural and functional modifications may be made without departing from the scope of the present disclosure.

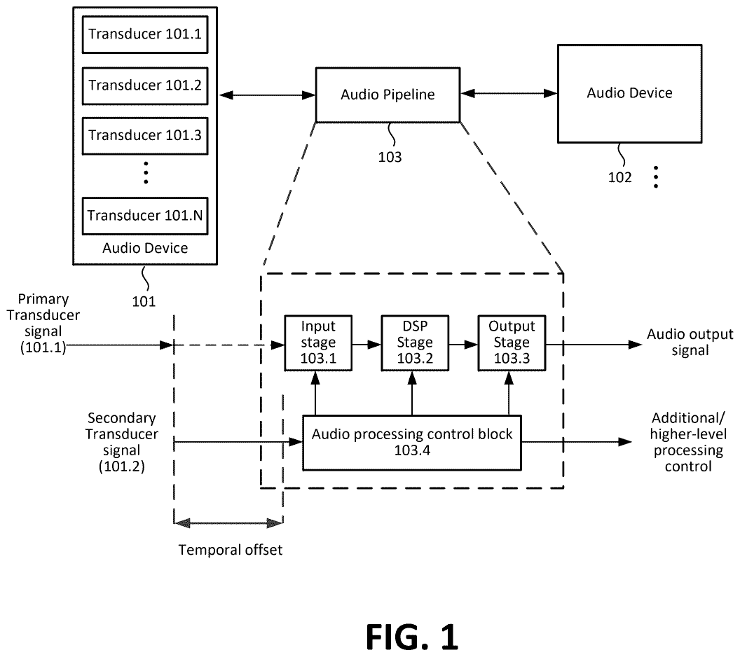

FIG. 1 illustrates a block diagram of an example audio system that may be used to implement one or more illustrative aspects described herein. The audio system 100 may comprise any suitable number of audio devices, such as audio device 101 and audio device 102. The audio devices 101, 102 may be communicatively coupled to one another via an audio pipeline 103, which may comprise any suitable type of medium. The audio pipeline 103 may couple power and/or control signals to the audio device 101 and/or the audio device 102. Additionally or alternatively, the audio pipeline 103 may comprise one or more hardware and/or software components configured to communicate with one or more components of the audio device 101 and/or the audio device 102, as well as perform audio processing (e.g., modifying, storing, and/or operating in response to) received transducer signals, as discussed in further detail herein.

The audio devices 101, 102 may comprise any suitable type of device that may be capable of sending, receiving, and/or processing (e.g., modifying, storing, and/or operating in response to) audio. Non-limiting examples of audio devices include devices that are, or that include, microphone assemblies including one or more transducers, speakers, conferencing equipment, audio recorders, personal computers, servers, display devices (e.g., television or computer displays), networking devices, audio mixers, musical instruments, etc. For example, the audio device 101 may comprise a microphone assembly as discussed herein. As another example, the audio device 101 may comprise one or more audio electronic components of the microphone assembly as further discussed herein, such as one or more transducers and/or one or more electronic components associated with such transducers. As an additional example, the audio device 102 may be or otherwise include a speaker. Each of the audio devices 101, 102 may comprise any suitable number and/or type of individual components, e.g., several transducers, speakers, etc., which are interconnected via the audio pipeline 103, and thus the audio system 100 may comprise a multiple-input, multiple-output audio system in such cases.

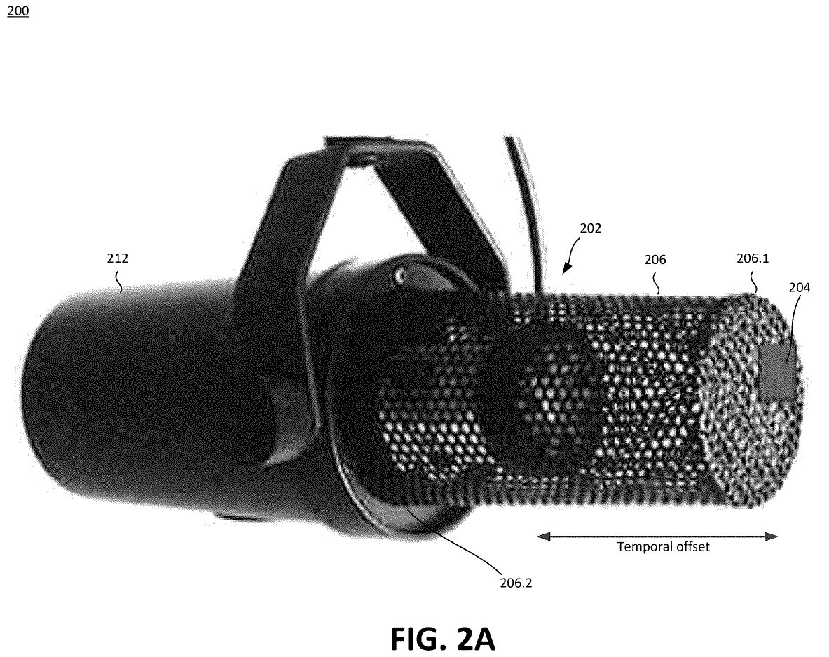

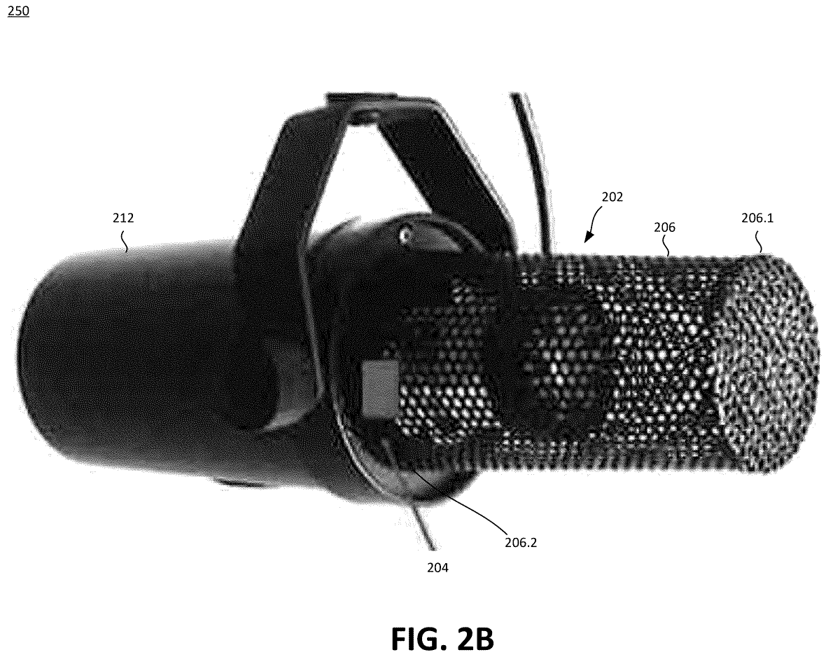

When implemented as a microphone assembly, the audio device 101 may be identified, for example, with any of the example microphone assemblies 200, 250 as shown in FIGS. 2A-2B and discussed in further detail herein. The audio device 102, when implemented as a speaker, may be configured to generate sound in response to the output signals output via the audio pipeline 103, which are generated in response to one or more of the received transducer signals received via the audio device 101, as discussed herein.

It is noted that although the embodiments discussed herein reference a single primary transducer and a single secondary transducer as part of the audio device 101, this is for ease of explanation and not by way of limitation. For instance, and as shown in FIGS. 1A-1B, the audio device 101 may be implemented as a microphone assembly having any suitable number N of transducers 101.1-101.N, each being configured to generate a respective transducer signal as shown. The transducers 101.1-101.N may be implemented as any suitable type of transducers, which may be the same transducer types or different transducer types than one another.

Thus, the transducer signals generated via the respective transducers 101.1-101.N may represent any suitable type of analog or digital signal that is representative of a physical measurement in accordance with the particular transducer type. For instance, one or more of the transducers 101.1-101.N may be implemented as audio transducers (e.g. microphones), vibration transducers, accelerometers configured to measure acceleration in any suitable number of axes, gyroscopes, inertial measurement units (IMUs), etc. Regardless of the particular implementation of the transducers 101.1-101.N, the audio pipeline 103 may process any of the transducer signals received from the transducers 101.1-101.N for various purposes, as discussed in further detail below.

The audio pipeline 103 may be implemented as part of a device that may be co-located in the same environment as the audio devices 101, 102. In this scenario, the audio pipeline 103 may be implemented as part of any suitable type of audio device, which may interface with the audio devices 101, 102 via any suitable configuration of wired and/or wireless links, ports, interfaces, etc. Additionally, the various components of the audio pipeline 103 may be interconnected with one another via any suitable number and/or type of wired and/or wireless links, ports, terminals, etc. Thus, the various arrows as shown in FIG. 1 may represent wired or wireless connections that enable the interconnection of the various components of the audio system 100 and the operation thereof. In various embodiments, the location of components in the audio pipeline 103 and any of their accompanying functions may reside physically within one of the audio devices 101, 102 and/or the audio pipeline 103. As one illustrative example, any of the components of the audio pipeline 103 (or components providing an equivalent functionality) may be additionally or alternatively integrated as part of the audio device 101, such as part of a microphone handle for instance. Alternatively, such components and/or or components providing an equivalent functionality may be executed by any suitable components that may be external to the audio system 100. As another illustrative example, the audio device 101 may be implemented as a microphone that wirelessly transmits signals from any of the transducers 101.1-101.N. These transmitted signals may then be wirelessly received by an external component (not shown), such as a receiver, mixer, computer, executed software components, a mobile phone, etc. These external components may, in such scenarios, perform any suitable portion and/or combination of the functions as described herein with respect to any components of the audio pipeline 103.

As another example, the audio pipeline 103 may be implemented as part of an audio device in which the audio devices 101, 102 may be connected as part of the audio system 100, and which may be used in any suitable environment in which the audio devices 101, 102 may also be used. Again, the audio devices 101, 102 and the audio pipeline 103 may be co-located, or any combination of the audio devices 101, 102 and the audio pipeline 103 may be co-located or located remote from one another. The audio pipeline 103 may be configured to couple the audio signals received via the audio device 101 to the audio device 102 and, in doing so, perform any suitable type of audio processing such as analog and/or digital signal conditioning, which may include for instance digital signal processing (DSP), which may include the execution of DSP operations (e.g. in accordance with an executed DSP algorithm) on audio samples corresponding to a received transducer signal, filtering, amplification, compression, encoding, decoding, etc. As another example, the audio pipeline 103 may be implemented as part of a communication network (e.g., a cloud computing device, a server, etc.) and/or may be coupled to the audio devices 101, 102 via such a communication network.

With respect to the primary transducer, e.g. transducer 101.1, which may comprise a microphone, audio data may be generated therefrom and represented as the primary transducer signal as shown in FIG. 1. The primary transducer signal may be generated based on sound detected by the transducer 101.1, which may be subjected to audio processing via the audio pipeline 103 to generate the corresponding output audio signal that is transmitted to at least the audio device 102. The audio device 102 may accordingly cause its speaker to generate sound based on the received audio data (e.g. the audio output signal).

This is but one example-as another example, each of the audio devices 101 and 102 may include both a microphone and a speaker. As a further example, the audio device 101 may include a microphone and the audio device 102 may include a computing device configured to store audio data received from the audio device 101. In such a case, it is noted that the various transducers 101.1-101.N would be implemented via the audio device 102, which is not shown in FIG. 1 for brevity and ease of explanation. As a further example, the audio devices 101 and 102 may each be elements of a teleconferencing or videoconferencing system. As a further example, the audio devices 101 and 102 may each be elements of a public address system.

Although the details thereof are not shown in the Figures for purposes of brevity, when implemented as part of the audio pipeline 103, the communication network may be any suitable type of network (including a simple connection between audio devices 101, 102) using any suitable number and/or type of protocols. For example, the communication network may utilize Internet Protocol (IP) to carry data such as audio data in IP datagrams. The communication network may send such IP datagrams using a particular data link layer protocol, such as Ethernet. This combination of IP and Ethernet is known as IP Over Ethernet (IPoE), in which data (such as audio data) is placed in IP datagrams, and the IP datagrams may be encapsulated in Ethernet frames. The term “packet” will be used herein to include various organized groupings of data, such as but not limited to datagrams (for example, User Data Protocol (UDP) datagrams) and frames.

Each of the audio devices 101, 102 may therefore be configured to send, via the audio pipeline 103, data to one or more other audio devices. Each of the audio devices 101, 102 may further be configured to receive, via the audio pipeline 103, data from one or more other audio devices. Any of the audio devices may be configured to both send and receive data, to exclusively send data, or to exclusively receive data. For example, the audio device 101 may be configured to send and/or receive data via the audio pipeline 103 to and/or from the audio device 102, and the audio device 102 may be configured to send and/or receive data via the audio pipeline 103 to and/or from the audio device 101. The data sent between the audio devices 101, 102 may include audio data, video data, transducer signal data, communication control data, system control data, audio processing parameter data, and/or any other suitable types of data.

The audio pipeline 103 may be implemented as any suitable number and/or type of hardware components, software components, or combinations of these to perform any functional aspects of the embodiments as discussed herein. The various components of the audio pipeline 103 may perform the audio processing of the transducer signal 101.1 via execution of their respective functions, which may be performed in accordance with a particular audio processing configuration. This audio processing configuration may implement one or more relevant parameters, as discussed in further detail herein, such that setting and/or adjusting these parameters defines a particular audio processing configuration.

To perform the audio processing, the audio pipeline 103 may comprise any suitable combination of hardware components and/or software components, which may include the execution of any suitable algorithms such as DSP algorithms, for instance. For example, the audio pipeline 103 may comprise an input stage 103.1, a DSP stage 103.2, and an output stage 103.3. The various stages of the audio pipeline 103 as shown in FIG. 1 are provided by way of example and not limitation, and the audio pipeline 103 may include additional, fewer, or alternate stages than those discussed herein to perform audio processing of the primary transducer signal. Furthermore, the functions performed by each of the stages of the audio pipeline 103 are also provided by way of example and not limitation, as any of the stages of the audio pipeline 103 may perform these functions or, alternatively, one or more functions of the various stages may be combined and performed by such a combined stage.

In the present example, the transducer 101.1 may be implemented as the primary transducer, such as an audio transducer (e.g. a microphone), and thus the primary transducer signal may comprise an audio signal. The primary transducer signal may comprise an analog signal or a digital signal, and in the latter case the audio device 101 and/or the transducer 101.1 may comprise suitable components to convert the analog-generated audio signal to a digital signal comprising audio samples, which is then transmitted to the audio pipeline 103 as the transducer signal as shown in FIG. 1.

The input stage 103.1 may comprise any suitable hardware components, software components, or combinations of these to perform initial signal conditioning of the primary transducer signal. The input stage 103.1 may include, for instance, an analog-to-digital converter (ADC) configured to convert the primary transducer signal to a digital format (when received in an analog format as noted above), which may comprise a digital audio sample data stream. Additionally or alternatively, the input stage 103.1 may perform decoding of the primary transducer signal. This may be the case, for instance, if the primary transducer signal is compressed, to thus decode the primary transducer signal into a “raw” (e.g. PCM) formatted signal. Additionally or alternatively, the input stage 103.1 may include one or more hardware components that may operate in the analog domain, such as one or more amplifiers having an adjustable gain, automatic gain control (AGC) circuitry, analog filters, etc.

Thus, and with respect to the input stage 103.1, the operating parameters for a particular audio processing configuration may include one or more settings used in accordance with such functions. This may include, for instance, a resolution of one or more ADCs, a gain setting of one or more amplifiers, a gain setting implemented via AGC circuitry, a filter transfer function, a decoding sampling rate, a type of decoding, etc.

The DSP stage 103.2 may function to perform any suitable number and/or type of DSP operations on the digital audio sample data stream output via the input stage 103.1. Of course, for implementations in which the input stage 103.1 is omitted, the DSP stage 103.2 may perform these DSP operations directly on primary transducer signal, which again may comprise a digital audio sample data stream. The DSP operations performed via the DSP stage 103.2 may include any suitable type of DSP operations, including known types used for audio processing applications. These may include, for instance, DSP operations that may be performed via any suitable executed DSP algorithm. Thus, the DSP stage 103.2 may include one or more DSPs and/or one or more suitable processing components configured to execute a DSP algorithm to perform such DSP operations.

To provide several examples, the DSP stage 103.2 may perform pre-processing on the digital audio sample data stream (either received via the input stage 103.1 or the transducer 101.1). This may include, for instance, tasks such as a gain adjustment (e.g. setting the overall volume level of the audio system 100), noise reduction/cancellation (e.g. eliminating or at least reducing unwanted background noise), and/or equalization (EQ) (e.g. adjusting the frequency content of the audio). Additionally or alternatively, the DSP stage 103.2 may perform the execution of the “core” DSP algorithms, which may include for instance primary audio processing operations such as filtering (e.g. applying filters to shape the audio's frequency response), compression/limiting (e.g. reducing the dynamic range of the audio), reverb/delay (e.g. adding artificial reverberation or delay effects), time stretching/pitch shifting (e.g. modifying the tempo or pitch of the audio), etc. Additionally or alternatively, the DSP stage 103.2 may perform a power estimation function using any suitable techniques, including known techniques, to determine sound pressure levels for setting any other suitable parameters of the audio pipeline 103 (e.g. AGC).

Thus, and with respect to the DSP stage 103.2, the parameters for a particular audio processing configuration may include one or more settings used in accordance with such functions. This may include, for instance, one or more gain settings for the gain adjustment, a level of noise reduction, any suitable EQ settings, the type or filter and/or filter parameters such as the transfer function (e.g. filter coefficients, poles, etc.), a type of and/or one or more settings used for compression/limiting, one or more settings used for reverb/delay, one or more settings used for time stretching/pitch shifting, any parameters used via the execution of a DSP algorithm to perform a power estimation function, etc.

The output stage 103.3 may function to perform post-processing of the processed digital audio sample data stream output via the DSP stage 103.2, which results in the audio output signal as shown in FIG. 1. To provide several examples, the output stage 103.3 may perform tasks such as mastering (e.g. performing final adjustments to the audio's overall sound quality), encoding (if applicable), converting the processed audio back to a compressed format for storage or transmission, etc.

Thus, and with respect to the output stage 103.3, the parameters for a particular audio processing configuration may include one or more settings used in accordance with such functions. This may include, for instance, one or more settings used for the audio mastering, one or more settings used for encoding, one or more settings used for converting the processed audio back to a compressed format for storage or transmission, which may include a compression format type and/or rate, etc.

Again, the audio pipeline 103 may perform audio processing of the primary transducer signal in accordance with a specific audio processing configuration, which may be defined in accordance with one or more parameters. These one or more parameters may include any combination of those described above with respect to the functions performed via the input stage 103.1, the DSP stage 103.2, and the output stage 103.3. However, these parameters have been provided by way of example and not limitation, and additional, fewer, or alternate parameters may be used in accordance with a specific audio processing configuration, including those known to be used for such a purpose.

Again, the transducer 101.2 may be implemented as a secondary transducer, which (like the transducer 101.1 in this example) may also be an audio transducer or, alternatively, be a different type of transducer, as discussed in further detail herein. The primary and secondary transducer signals may be generated, transmitted, received, and processed via the audio pipeline 103 independently of one another. Additionally, and as further discussed below, the secondary transducer signal may be generated prior to the generation of the primary transducer signal and be received by the audio pipeline 103 prior to the primary transducer signal. Thus, and as shown in FIG. 1, the primary and secondary transducer signals may be received via the audio pipeline 103 having a temporal offset with respect to one another. This temporal offset may translate to a temporal offset in terms of a number of samples of the secondary transducer signal that may be processed before the primary transducer signal is received. The degree of this temporal offset may be a function of the manner in which the transducers 101.1, 101.2 are disposed on the audio device 101, as well as the transducer types.

As a result of this configuration, the audio pipeline 103 may exploit information provided by the initially-received secondary transducer signal to pre-configure the audio pipeline 103 prior to receiving the primary transducer signal. To do so, the audio pipeline 103 may further comprise an audio processing control block 103.4, which may include any suitable number and/or type of hardware components (e.g. processors or processing circuitry), software components, or combinations of these. Thus, the audio processing control block 103.4 may receive the secondary transducer signal prior to receiving the primary transducer signal. Then, during a time duration represented by the temporal offset as shown in FIG. 1, the audio processing control block 103.4 may analyze the secondary transducer signal and pre-configure the audio pipeline 103 prior to receiving the primary transducer signal. This may be performed, for instance, via any suitable number and/or type of control signals, which may be represented in FIG. 1 as the arrows connecting the audio processing control block 103.4 with the different stages of the audio pipeline 103. As a result, a pre-configuration of the audio pipeline 103 may be established for performing audio processing of the primary transducer signal by setting any combination of parameters described above. This may include, for example, those described with respect to the functions performed via the input stage 103.1, the DSP stage 103.2, and the output stage 103.3, or any other parameters or functions as described herein.

To provide an illustrative example, the audio processing control block 103.4 may analyze the secondary transducer signal to determine a current sound level, which may then be correlated to an AGC gain setting for that particular sound level. The audio processing control block 103.4 may then provide a gain adjustment of the AGC circuitry included in any of the input stage 103.1, the DSP stage 103.2, and/or the output stage 103.3 prior to receiving the second transducer signal. As a result of this adjustment to the AGC, audio clipping in the output audio signal, which would otherwise result from performing audio processing of the primary transducer signal, may be prevented or at least reduced.

As another illustrative example, the audio processing control block 103.4 may analyze the secondary transducer signal to perform pop detection. For instance, the audio processing control block 103.4 may analyze the secondary transducer signal to determine plosives in the received audio path. To this end, it is noted that although conventional post-production techniques may remove pops, plosives are difficult to identify in real time due to the short duration of transients that cause them. Thus, the audio processing control block 103.4 may perform a rolling analysis window to locate the position of plosives in the secondary transducer signal. In response, the audio processing control block 103.4 may implement any suitable mitigating techniques, which may then be utilized as part of the processing performed by one or more of the input stage 103.1, the DSP stage 103.2, the output stage 103.3, etc., by setting the various parameters of these audio pipeline stages and then applying any suitable mitigation techniques to the primary transducer signal once it has been received. This may include, for instance, the implementation of one or more limiters, one or more compressors, one or more frequency masks, any other suitable techniques that aim to eliminate (or at least reduce) the identified plosive(s) from the primary transducer signal, etc.

As yet another illustrative example, the audio processing control block 103.4 may analyze the secondary transducer signal to perform clipping prevention with respect to the primary transducer signal. This process may be similar to the implementation of pop detection as described above, but utilize a multi-sample window that analyzes the secondary transducer signal. As part of this process, any suitable risk of digital or analog clipping may be identified. The audio processing control block 103.4 may implement any suitable mitigating techniques, which may then be utilized as part of the processing performed by one or more of the input stage 103.1, the DSP stage 103.2, the output stage 103.3, etc., by setting the various parameters of these audio pipeline stages and then applying any suitable mitigation techniques to the primary transducer signal once it has been received. This may include, for instance, the adjustment of the digital and/or analog gain, the implementation of one or more limiters, one or more compressors, or any suitable techniques to prevent or at least reduce clipping.

As a further illustrative example, the audio processing control block 103.4 may analyze the secondary transducer signal to implement voice changing and/or voice modification. For instance, voice changers (e.g. AI voice changers) have recently grown in popularity, but these changers may be inherently slow due to the conversions used before feeding a voice model. For instance, voice changing typically requires, at a minimum, calculating a Fast Fourier Transform (FFT) input to the model and an IFFT after the model to transition the signal back into the time domain. The accuracy, effectiveness, and/or quality of the voice model is thus directly tied to both the resolution of the FFT (a higher resolution takes longer) and the amount of time voice model has to iterate on the signal (e.g. the buffer size). Thus, the audio processing control block 103.4 may analyze the secondary transducer signal to inform such a voice model ahead of receiving the primary transducer signal. For example, an analysis of the secondary transcoder signal may be performed to determine parameters of an FFT and/or the calculation of coefficients thereof, which may be applied as the coefficients that are provided to the voice model for the primary signal.

As yet another illustrative example, the audio processing control block 103.4 may analyze the secondary transducer signal to implement noise reduction in accordance with any suitable techniques, such as AI, a machine learning model, and/or standard noise reduction for instance. Such noise reduction techniques may benefit from large buffer windows and function most ideally as part of a post processing step. In the current example, similar to the voice changing implementation described above, the audio processing control block 103.4 may analyze the secondary transducer signal for spectral components and/or to generate coefficients, which ay then be applied to the primary transducer signal once it has been received to significantly reduce processing delays.

To provide a further illustrative example, the audio processing control block 103.4 may analyze the secondary transducer signal to implement pitch correction. For instance, live pitch correction has become an ubiquitous tool for audio production studios, and has made its way to live stage applications with much success. However, the current use of pitch correction adds latency and often causes artifacts due to “grabbing” onto the wrong sound and falsely correcting it. Thus, and continuing this example, the audio processing control block 103.4 may analyze the secondary transducer signal to provide a much larger window to lock onto the correct sound. This information may then be applied to the primary transducer signal such that the pitch correction calculations are already tuned properly when the primary transducer signal has been received.

Any of the illustrative examples described above, as well as any of the other techniques described herein that may leverage the analysis of the secondary transducer signal via the audio processing control block 103.4, may be performed by any suitable components of the audio pipeline 103, the audio system 100, or external components, as noted herein. This may include DSP operations performed via the DSP stage 103.2 on the first and/or the second transducer signal, as discussed herein. Alternatively, the DSP operations may be performed by alternate components other than the DSP stage 103.2. In any event, the DSP operations as discussed herein may include the execution of any suitable processes, algorithms, etc., to realize any of the functions as discussed herein, which may be performed on the primary transducer signal based upon any suitable analysis of characteristics of the secondary transducer signal. Again, this may include the use of AI modeling, performing real-time AI voice changing models, clipping prevention, real time pitch correction, pop detection, voice changing and/or voice modification, noise reduction, assisting with voice isolation, other audio-based functions as described herein, or any other suitable alternatively audio processing operations that may leverage the use of an analysis of the secondary transducer signal, as noted herein. The analysis of the secondary transducer signal in this manner advantageously allows for the audio processing to be pre-configured before the primary transducer signal is received (or at least prior to processing the primary transducer signal). This significantly reduces the time that would otherwise be required to do so using conventional feedback monitoring techniques. Thus, the latency that would otherwise be present in a conventional audio system may be significantly reduced via the implementation of the secondary transducer 101.2. To this end, it is noted that although an additional secondary transducer is used for this purpose, the cost of adding an additional transducer may be relatively small, as the secondary transducer may be of a lower quality and/or lower cost compared to the primary transducer 101.1. This is because the secondary transducer signal is not being used to actually produce sound, which is provided via audio processing of the primary transducer signal, as noted above.

Again, the audio processing control block 103.4 may pre-configure the audio processing performed by the audio pipeline 103 on the primary transducer signal. The various examples discussed herein focus on setting the various parameters of the audio pipeline stages that may define the audio processing configuration. However, the embodiments discussed herein are not limited to adjusting the audio pipeline components, and may additionally or alternatively include using the analysis of the secondary transducer signal in advance of receiving the primary transducer signal to determine and/or set other suitable parameters that may be implemented in accordance with other systems, processes, and/or applications that may form part of and/or be in communication with the audio system 100.

That is, the embodiments discussed herein are not limited to utilizing the secondary transducer signal to perform audio processing via the audio pipeline 103 (or audio processing at all). Instead, the audio processing control block 103.4 may use any information gathered from an analysis of the secondary transducer signal for any suitable purpose. To provide some illustrative examples, the audio processing control block 103.4 may communicate with one or more additional or alternate components of the audio system, which may include higher-level processing control components such as system-level applications, an operating system, etc., as shown in FIG. 1.

Thus, and as shown in FIG. 1, the audio processing control block 103.4 may provide a determination of a specific higher-level function to these higher-level processing control components by analyzing the secondary transducer signal. Alternatively, the audio processing control block 103.4 may forward the secondary transducer signal to such components, which may determine a manner in which this information may be utilized. To provide some illustrative examples, the secondary transducer signal may provide information that may be used for artificial intelligence (AI) modeling, for performing real-time AI voice changing models, clipping prevention, real time pitch correction, pop detection, voice changing and/or voice modification, noise reduction, assisting with voice isolation, etc.

Thus, the audio processing control block 103.4 may pre-configure the audio processing for the primary transducer signal by setting and/or adjusting various parameters that define the audio processing configuration, as noted above. Additionally or alternatively, the analysis of the secondary transducer signal may be utilized for various higher-level functions. In any event, to do so, the secondary transducer signal may be received by the audio pipeline 103 prior to the primary transducer signal, as noted herein. This may be achieved in various ways, which includes how the transducers are disposed on the audio device 101 and the type of transducers, as further discussed with respect to FIGS. 2A-2B below.

FIGS. 2A-2B illustrate block diagrams of two different example microphone assemblies that may be used to implement one or more illustrative aspects described herein. In a first implementation as shown in FIG. 2A, a microphone assembly 200 is shown, which may be identified with the audio device 101, for example. The microphone assembly 200 includes a housing 212 and a microphone grill 206. The microphone grill 206 may be comprised of any suitable material, such as metal or a composite material for example, has a grill face 206.1 at a distal end of the microphone grill 206, and a grill base 206.2 that is disposed opposite to the grill face 206.1 at the bottom of the microphone grill 206 where the microphone grill 206 abuts the housing 212. In this arrangement, the grill face 206.1 is the closest portion of the microphone assembly 200 to a user's mouth during use.

The microphone assembly 200 further includes a primary transducer 202, which may be identified for example with the transducer 101.1 as shown and discussed above with respect to FIG. 1. The microphone assembly 200 further includes a secondary transducer 204, which may be identified for example with the transducer 101.2 as shown and discussed above with respect to FIG. 1. As shown in FIG. 2A, the primary and secondary transducers 202, 204 are disposed on the microphone grill 206 spatially offset from one another.

For the microphone assembly 200 as shown in FIG. 2A, the first and second transducers 202, 204 may be the same type of audio transducer, such as an audio transducer, but this need not be the case, and the first and second transducers 202, 204 may be different transducer types. However, it may be particularly advantageous for the first and second transducers 202, 204 to be audio transducers, as the secondary transcoder 204 is located closer to where the user's mouth is to be positioned with respect to the microphone grill 206 compared to that of the primary transducer 202. Specifically, and as shown in FIG. 2A, the primary transducer 202 may be disposed between the grill face 206.1 and the grill base 206.2, and the secondary transducer 204 may be disposed on the grill face 206.1.

Of course, the specific arrangement of the primary and secondary transducers 202, 204 is illustrative and not limiting, and the primary and secondary transducers 202, 204 may be disposed on any suitable portions of the microphone assembly 200. Furthermore, the temporal offset between the transducer signals respectively generated by the primary and secondary transducers 202, 204 is a function of the spatial offset between them. Thus, the temporal offset may be adjusted for a particular application by adjusting this spatial offset. For the microphone assembly 200 as shown in FIG. 2A, the secondary transducer 204 is positioned closer to the source of the sound waves (e.g. the user's mouth) than the primary transducer 202, so the secondary transducer signal is generated before the primary transducer signal in the presence of the same audio source.

Turning now to FIG. 2B, a microphone assembly 250 is shown, which may also be identified with the audio device 101, for example. The microphone assembly 250 may include the same components as the microphone assembly 200 as discussed above with respect to FIG. 2A, and any of the statements made with respect to the microphone assembly 200 may also apply to the microphone assembly 250, excepting for the various differences as noted below.

The microphone assembly 250 also comprises the primary and secondary transducers 202, 204, which are spatially offset from one another. However, for the microphone assembly 250, the primary transducer 202 is disposed between the grill face 206.1 and the secondary transducer 204. Thus, although the microphone assembly 250 includes a secondary transducer 204 disposed further from the audio source compared to the primary transducer 202, the secondary transducer 204 may nonetheless still generate the secondary transducer signal prior to the primary transducer 202 generating the primary transducer signal.

To do so, the primary and secondary transducers 202, 204 may be implemented as different transducer types and, more specifically, as transducers configured to operate in different mediums. The propagation speed of sound in the medium used by the secondary transducer 204 may be faster than the propagation speed of sound in the medium used by the primary transducer 202. To provide an illustrative example, the primary transducer 202 may be implemented as an audio transducer. However, the secondary transducer may be implemented as a vibration transducer configured to generate a secondary transducer signal responsive to vibrations induced into the microphone grill 206. Thus, in this configuration, the sound waves from a source reach the grill face 206.1 initially, which induce vibrations in the microphone grill 206. And because the microphone grill 206 may be comprised of metal, the propagation speed of sound in the metallic microphone grill 206 is faster than that of air. Thus, the secondary transducer 204 receives the vibrations caused by the sound waves prior to the sound waves reaching the primary transducer 202.

Of course, because the secondary transducer 204 may not be implemented as an audio transducer in this arrangement, the transducer signal generated via the secondary transducer 204 and received via the audio pipeline 103 may not represent direct audio information. For instance, the transducer signal generated via the secondary transducer 204 may comprise accelerometer data, gyroscopic data, IMU data, or any other suitable data that may be used to represent vibrations in the microphone grill 206 caused by emitted sound waves. Thus, in such cases, the audio processing control block 103.4 may be configured to correlate the second transducer signal to a predetermined parameter for audio processing. The audio processing control block 103.4 may thus pre-configure the audio processing to be performed on the first transducer signal by using one or more of the correlated predetermined parameters as the one or more parameters of the audio processing configuration, as noted above.

To provide an illustrative example, the audio processing control block 103.4 may store or otherwise access any suitable type of correlation data, such as a lookup table (LUT) for example. This correlation data may correlate specific values of the transducer signal generated via the secondary transducer 204 with one or more predetermined parameters used for the configuration of the audio processing performed via the audio pipeline 103. For instance, the secondary transducer signal may indicate various intensities of vibrations and/or different frequencies of vibration. A calibration or other suitable controlled measurement process may thus be performed that enables the characteristics of the secondary transducer to be mapped to specific sound characteristics.

This information may then be used to construct a correlation of the sound characteristics indicated by the secondary transducer signal to specific parameters that are to be set as part of the pre-configuration of the audio processing for the primary transducer signal. Thus, and continuing this example, when the secondary transducer signal indicates a vibration intensity between a predetermined range of amplitudes, the audio processing control block 103.4 may determine that the AGC setting used for the audio processing configuration should be reduced to a predetermined setting. This determination may be based upon a correlation between the vibration intensity and a corresponding AGC setting. Of course, the use of AGC is but one example, and such correlation techniques may be used to map any suitable properties of the secondary transceiver signal with a desired configuration of the audio processing to be performed on the primary transducer signal by setting any suitable parameters prior to its receipt, as noted herein.

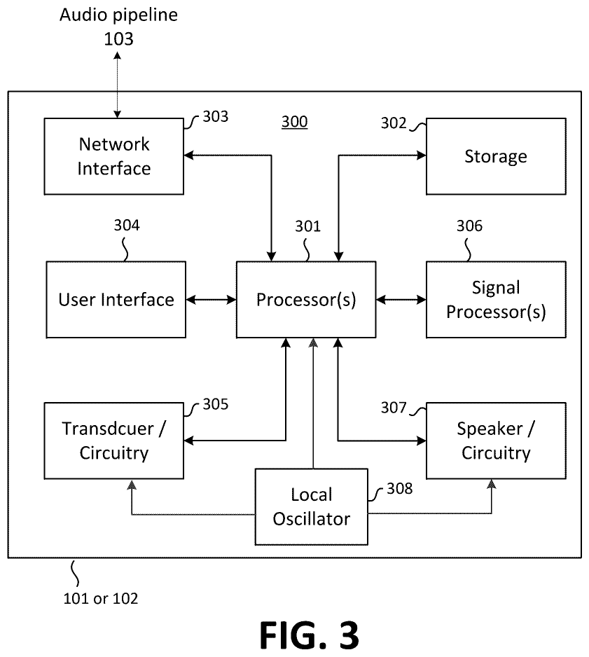

FIG. 3 is a block diagram showing example details of the various components that may be part of an audio system in accordance with one or more illustrative aspects described herein. The block diagram as shown in FIG. 3 may, for example, represent details of an audio device 300 that may be part of an audio system, such as the audio system 100 of FIG. 1. For example, the audio device 300 may be identified with the audio device 101 or the audio device 102. Additionally or alternatively, any of the components and/or functions described with respect to the audio device 300 may be implemented via the audio pipeline 103, in which case such components and functions may be offloaded and/or omitted from the device 101 and/or the audio device 102. Furthermore, any of the components and/or functions described with respect to the audio device 300 are described by way of example and ease of explanation, and may be shared and/or combined among any of the audio devices 101, 102, and/or the audio pipeline 103.

The audio device 300 may be implemented as or may otherwise include, for example, a computing device that executes stored instructions, and/or as hard-wired circuitry and/or as one or more processors that may execute stored computer-readable instructions. In the shown example, the audio device 300 may comprise or be connected to any of the following: one or more processors 301, storage 302 (which may comprise one or more computer-readable media such as memory), an external interface such as a network interface 303 (which may be configured to communicate with a network and/or the audio pipeline 103), a user interface 304, one or more transducers (e.g. microphones, non-audio transducers, etc.) and/or associated elements 305 configured to detect sound, vibrations, etc., and convert these detected physical quantities into transducer signals such as an analog transducer signal or a digital transducer signal, one or more digital signal processors 306 configured to implement one or more digital signal processing features of the audio device, one or more speakers and/or associated elements 307 configured to produce sound in response to a received audio signal such as an analog audio signal or a digital audio signal, and/or a local oscillator 308. The one or more processors 301 may be communicatively connected to any of the other elements 302-308 via one or more data buses and/or via one or more other types of connections.

The audio device 300 as shown in FIG. 3 is provided by way of example and not limitation, and may include additional, fewer, or alternate components. For example, the audio device 300 as shown in FIG. 3 may be identified with any suitable portion of any of the microphone assemblies as discussed herein, such as the microphone assemblies 200/250 as shown and described with respect to FIGS. 2A-2B, for example. In such scenarios, the audio device 300 may not include the one or more speakers and/or associated elements 307, the user interface 304, etc. As another example, when the audio device 300 may be implemented as part of a microphone assembly 200/250 as discussed herein, the network interface 303 may comprise a connector and associated circuity, electronic components, etc. that facilitate the microphone assembly 200/250 receiving power and control data, transmitting transducer signals, etc., as discussed herein.

The circuitry of elements 305 and 307 may be separate circuitry or a single instance of combined circuitry, as desired. In the shown example, the local oscillator 308 may provide a local asynchronous clock signal to the one or more processors 301, the circuitry of element 305, and the circuitry of element 307. However, the local asynchronous clock signal may be provided to any of the elements of FIG. 3, as desired. In an example, the one or more processors 301 may receive a signal from the local oscillator 308, and the one or more processors 301 may generate the asynchronous local clock based on the signal from the local oscillator 308. For example, the one or more processors 301 may comprise phase-locked loop (PLL) circuitry, and the signal from the local oscillator 308 may be an input to (e.g., for driving) the PLL circuitry.

The one or more processors 301 may be configured to execute instructions stored in storage 302. The instructions, when executed by the one or more processors 301, may cause the computing device (and thus the audio device) to perform any of the functionality described herein that may be performed by the audio device 300 (such as the audio device 101 or the audio device 102). For example, the one or more processors 301 may control the operation of any of the other elements 302-308 of the audio device 300, and/or may direct various signals (such as audio signals and/or clock signals) amongst the various elements 302-308 of the audio device.

Power may be provided to the audio device 300 and/or to any of the elements of the audio device (e.g., any of the elements 301-308) as desired. While not explicitly shown, the audio device 300 may include an internal battery and/or an external power connection.

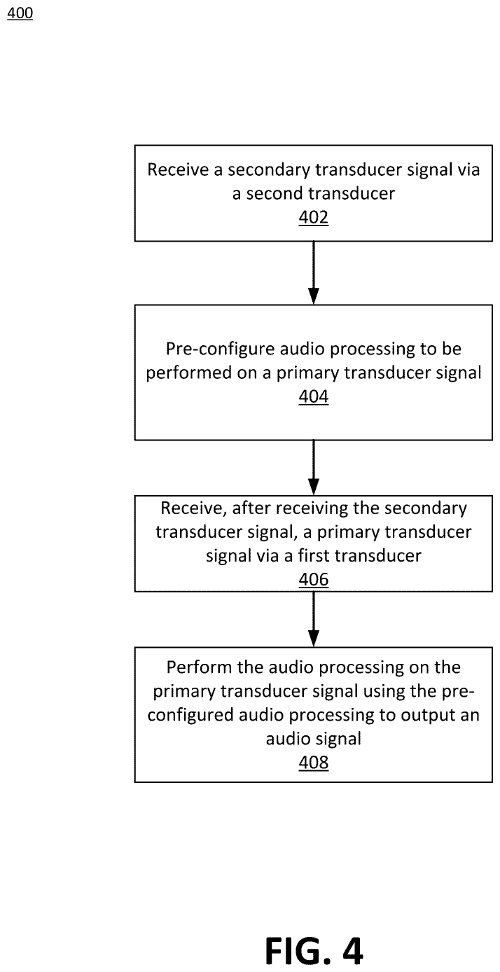

FIG. 4 illustrates an example flow chart of a process that may be performed to assemble a microphone assembly in accordance with one or more illustrative aspects described herein. The flow 400 may comprise a process flow that may be executed by and/or otherwise associated with any suitable automated, semi-automated, or manual process that may perform, for example, any of the functions of the audio system 100 as discussed herein. The flow 400 may thus may be implemented via the any suitable number and/or type of components, which may comprise portions of the audio devices 101, 102, and/or the audio pipeline 103, for example. The flow 400 may include alternate or additional processes that are not shown for purposes of brevity, and may be performed in a different order than those shown.

Flow 400 may begin by receiving (block 402) a secondary transducer signal via a secondary transducer. For example, block 402 may represent the audio pipeline 103 receiving the secondary transducer signal that is generated via the secondary transducer 101.2, as discussed herein with respect to FIG. 1.

The flow 400 may further comprise pre-configuring (block 404) the audio processing to be performed on a primary transducer signal, as discussed herein. This may include, for instance, setting and/or adjusting any suitable parameters used in accordance with the audio processing performed via the audio pipeline 103, as discussed herein with respect to FIG. 1. Additionally or alternatively, this may include adjusting other parameters that may be used by the audio system other than those implemented via the audio pipeline 103, as noted above.

The flow 400 may further comprise receiving (block 406) a primary transducer signal after the secondary transducer has been received (block 402). For example, block 406 may represent the audio pipeline 103 receiving the primary transducer signal (e.g. an audio signal) that is generated via the primary transducer 101.1, as discussed herein with respect to FIG. 1.

The flow 400 may further comprise performing (block 408) the audio processing on the primary transducer signal. This may include, for instance, using the pre-configured (block 404) audio processing, which is defined in accordance with the various parameters as noted herein, to output an audio signal. For example, block 408 may represent the audio pipeline 103 performing audio processing of the primary transducer signal (e.g. an audio signal) to generate an output audio signal, which is then transferred to a suitable audio device (e.g. audio device 102, such as a speaker for instance) to play a corresponding sound, as discussed herein with respect to FIG. 1.

An example microphone assembly may comprise a first transducer configured to generate a first transducer signal; and a second transducer spatially offset from the first transducer and configured to generate a second transducer signal before the first transducer generates the first transducer signal, the first transducer signal and the second transducer signal may be received by an audio pipeline independently of one another, and the second transducer signal may be received by the audio pipeline prior to the first transducer signal, which facilitates the audio pipeline pre-configuring audio processing to be performed on the first transducer signal in accordance with one or more parameters to output an audio signal. The first transducer and the second transducer may be different transducer types. The first transducer may comprise an audio transducer, and the second transducer may comprise a vibration transducer. The first transducer and the second transducer may comprise an audio transducer. The microphone assembly may further comprise a microphone grill comprising a grill face disposed at a distal end of the microphone grill, and a grill base that is disposed opposite to the grill face, the first transducer may be disposed between the grill face and the grill base, and the second transducer may be disposed on the grill face. The microphone assembly may further comprise a microphone grill comprising a grill face that is disposed at a distal end of the microphone grill, and a grill base that is disposed opposite to the grill face, and the first transducer may be disposed between the grill face and the second transducer. The first transducer and the second transducer may be configured to operate in a first medium and a second medium, respectively, and a propagation speed of sound in the second medium may be faster than a propagation speed of sound in the first medium.

An example audio system may comprise a microphone assembly comprising a first transducer and a second transducer spatially offset from one another; and an audio pipeline configured to: receive a second transducer signal generated via the second transducer independently of and prior to receiving a first transducer signal generated via the first transducer; and pre-configure, based upon an analysis of the second transducer signal, audio processing to be performed on the first transducer signal in accordance with one or more parameters to output an audio signal. The audio pipeline may comprise a digital signal processor (DSP) configured to execute DSP operations on the first transducer signal, and the one or more parameters used in accordance with the audio processing to be performed on the first transducer signal may comprise one or more parameters used in accordance with execution of the DSP operations. The audio pipeline may implement automatic gain control (AGC), and the one or more parameters used in accordance with the audio processing to be performed on the first transducer signal may comprise a gain adjustment of the AGC. The gain adjustment of the AGC may be performed prior to receiving the first transducer signal and prevent audio clipping in the output audio signal. The first transducer may comprise an audio transducer, and the second transducer may comprise a vibration transducer. The audio pipeline comprises processing circuitry may be configured to correlate the second transducer signal to a predetermined parameter for audio processing, and to pre-configure the audio processing to be performed on the first transducer signal by using, as the one or more parameters, the predetermined parameter. The first transducer and the second transducer may comprise an audio transducer.

An example method may comprise receiving a first transducer signal generated via a first transducer of a microphone assembly; receiving a second transducer signal generated via a second transducer of the microphone assembly, wherein the second transducer signal is received independently of and prior to receiving the first transducer signal; pre-configuring, based upon an analysis of the first transducer signal, audio processing to be performed on the first transducer signal in accordance with one or more parameters; and outputting an audio signal by performing the audio processing on the first transducer signal. The pre-configuring the audio processing may comprise setting, as the one or more parameters, a manner in which digital signal processing (DSP) operations are performed on the first transducer signal. The pre-configuring the audio processing may comprise adjusting, as the one or more parameters, a gain of an automatic gain control (AGC) to be applied to the first transducer signal. The gain of the AGC may be performed prior to receiving the first transducer signal and prevent audio clipping in the output audio signal. The audio processing to be performed on the first transducer signal in accordance with the one or more parameters may comprise performing one or more of: artificial intelligence (AI) modeling, real-time AI voice changing models, clipping prevention, real time pitch correction, pop detection, voice changing, voice modification, noise reduction, and functions associated with voice isolation. The method may further comprise correlating the second transducer signal to a predetermined parameter for audio processing, wherein the pre-configuring the audio processing may comprise using, as the one or more parameters, the predetermined parameter.

In the foregoing specification, the present disclosure has been described with reference to specific exemplary examples thereof. Although the invention has been described in terms of a preferred example, those skilled in the art will recognize that various modifications, examples or variations of the invention can be practiced within the spirit and scope of the invention as set forth in the appended claims. The specification and drawings are, therefore, to be regarded in an illustrated rather than restrictive sense. Accordingly, it is not intended that the invention be limited except as may be necessary in view of the appended claims.

Unless otherwise specified, the use of the serial adjectives, such as, “first,” “second,” “third,” and the like that are used to describe components, are used only to indicate different components, which can be similar components. But the use of such serial adjectives is not intended to imply that the components must be provided in given order, either temporally, spatially, in ranking, or in any other way.

Also, while the terms “front,” “back,” “side,” and the like may be used in this specification to describe various example features and elements, these terms are used herein as a matter of convenience, for example, based on the example orientations shown in the figures and/or the orientations in typical use. Nothing in this specification should be construed as requiring a specific three dimensional or spatial orientation of structures in order to fall within the scope of the claims.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A microphone assembly, comprising:
a first transducer configured to generate a first transducer signal; and
a second transducer spatially offset from the first transducer and configured to generate a second transducer signal before the first transducer generates the first transducer signal,
wherein the first transducer signal and the second transducer signal are received by an audio pipeline independently of one another, and
wherein the second transducer signal is received by the audio pipeline prior to the first transducer signal, which facilitates the audio pipeline pre-configuring audio processing to be performed on the first transducer signal in accordance with one or more parameters to output an audio signal.

2. The microphone assembly of claim 1, wherein the first transducer and the second transducer are different transducer types.

3. The microphone assembly of claim 1, wherein the first transducer comprises an audio transducer, and
wherein the second transducer comprises a vibration transducer.

4. The microphone assembly of claim 1, wherein the first transducer and the second transducer comprise an audio transducer.

5. The microphone assembly of claim 1, further comprising:
a microphone grill comprising a grill face disposed at a distal end of the microphone grill, and a grill base that is disposed opposite to the grill face,
wherein the first transducer is disposed between the grill face and the grill base, and
wherein the second transducer is disposed on the grill face.

6. The microphone assembly of claim 1, further comprising:
a microphone grill comprising a grill face that is disposed at a distal end of the microphone grill, and a grill base that is disposed opposite to the grill face, and
wherein the first transducer is disposed between the grill face and the second transducer.

7. The microphone assembly of claim 1, wherein the first transducer and the second transducer are configured to operate in a first medium and a second medium, respectively, and
wherein a propagation speed of sound in the second medium is faster than a propagation speed of sound in the first medium.

8. An audio system comprising:
a microphone assembly comprising a first transducer and a second transducer spatially offset from one another; and
an audio pipeline configured to:
receive a second transducer signal generated via the second transducer independently of and prior to receiving a first transducer signal generated via the first transducer; and
pre-configure, based upon an analysis of the second transducer signal, audio processing to be performed on the first transducer signal in accordance with one or more parameters to output an audio signal.

9. The audio system of claim 8, wherein the audio pipeline comprises a digital signal processor (DSP) configured to execute DSP operations on the first transducer signal, and
wherein the one or more parameters used in accordance with the audio processing to be performed on the first transducer signal comprise one or more parameters used in accordance with execution of the DSP operations.

10. The audio system of claim 9, wherein the audio pipeline implements automatic gain control (AGC), and
wherein the one or more parameters used in accordance with the audio processing to be performed on the first transducer signal comprise a gain adjustment of the AGC.

11. The audio system of claim 10, wherein the gain adjustment of the AGC is performed prior to receiving the first transducer signal and prevents audio clipping in the output audio signal.

12. The audio system of claim 8, wherein the first transducer comprises an audio transducer, and
wherein the second transducer comprises a vibration transducer.

13. The audio system of claim 8, wherein the audio pipeline comprises processing circuitry configured to correlate the second transducer signal to a predetermined parameter for audio processing, and to pre-configure the audio processing to be performed on the first transducer signal by using, as the one or more parameters, the predetermined parameter.

14. The audio system of claim 8, wherein the first transducer and the second transducer comprise an audio transducer.

15. A method, comprising:
receiving a first transducer signal generated via a first transducer of a microphone assembly;
receiving a second transducer signal generated via a second transducer of the microphone assembly,
wherein the second transducer signal is received independently of and prior to receiving the first transducer signal;
pre-configuring, based upon an analysis of the first transducer signal, audio processing to be performed on the first transducer signal in accordance with one or more parameters; and
outputting an audio signal by performing the audio processing on the first transducer signal.

16. The method of claim 15, wherein the pre-configuring the audio processing comprises setting, as the one or more parameters, a manner in which digital signal processing (DSP) operations are performed on the first transducer signal.

17. The method of claim 16, wherein the pre-configuring the audio processing comprises adjusting, as the one or more parameters, a gain of an automatic gain control (AGC) to be applied to the first transducer signal.

18. The method of claim 17, wherein the gain of the AGC is performed prior to receiving the first transducer signal and prevents audio clipping in the output audio signal.

19. The method of claim 15, wherein the audio processing to be performed on the first transducer signal in accordance with the one or more parameters comprises performing one or more of: artificial intelligence (AI) modeling, real-time AI voice changing models, clipping prevention, real time pitch correction, pop detection, voice changing, voice modification, noise reduction, and functions associated with voice isolation.

20. The method of claim 15, further comprising:
correlating the second transducer signal to a predetermined parameter for audio processing,
wherein the pre-configuring the audio processing comprises using, as the one or more parameters, the predetermined parameter.
